(19) United States
(12) Patent Application Publication
(10) Pub. No.: US 2026/0065541 A1
(43) Pub. Date: Mar. 5, 2026

(54) SYSTEMS AND METHODS FOR DEVELOPING AND IMPLEMENTING KNOWLEDGE GRAPHS USING LARGE LANGUAGE MODELS

(71) Applicant: Pearson Education, Inc., Bloomington, MN (US)

(72) Inventor: William VANDER LUGT, Englewood, CO (US)

(21) Appl. No.: 19/312,057

(22) Filed: Aug. 27, 2025

Related U.S. Application Data
(60) Provisional application No. 63/688,744, filed on Aug. 29, 2024.

(51) Int. Cl. G06T 11/20; G06F 16/248; G09B 5/02

(52) U.S. Cl. CPC G06T 11/26; G06F 16/248; G09B 5/02; G06T 2200/24

(57) ABSTRACT

Systems and methods are provided for developing and implementing knowledge graphs. One system may include a processing system including one or more electronic processors. The processing system may be configured to receive electronic content that includes a plurality of content portions arranged in a sequential order. The processing system may be configured to identify a plurality of nodes for the electronic content. The processing system may be configured to determine, from the plurality of nodes, a plurality of node pairings based on the sequential order of the electronic content. The processing system may be configured to determine a metric for each of the plurality of node pairings that indicates a respective degree of dependency associated with the corresponding node pairing. The processing system may be configured to generate a graphical representation that indicates relationships between the plurality of content portions of the electronic content.

### CROSS-REFERENCE TO RELATED APPLICATIONS

This application claims priority to U.S. Provisional Application No. 63/688,744, filed on Aug. 29, 2024, which is hereby incorporated by reference in its entirety.

### TECHNICAL FIELD

This disclosure relates to large language model (“LLM”) applications. LLMs have the ability to understand and process text. LLMs generally perform a variety of natural language processing (“NLP”) related tasks to produce content based on input prompts in human language.

The discussion above is merely provided for general background information and is not intended to be used as an aid in determining the scope of the claimed subject matter.

### SUMMARY

This disclosure is in the field of LLM applications, and more particularly, in the field of generating and implementing knowledge graphs using LLMs.

For decades, education companies have relied on human experts to create complex knowledge graphs that specify prerequisite-postrequisite relationships between concepts and skills, which in some instances can take almost two years to build a single graph. The advent of LLMs provides opportunities for use in creating such knowledge graphs, which are valuable in assessing students' proficiencies, in personalizing individual learning experiences based on those assessments, among other uses. Despite advances in LLMs, a broad request of an LLM to create a knowledge graph results in incomplete, low-quality, untrustworthy, and/or otherwise inadequate graphs. Thus, an LLM may not simply replace a human actor to create a knowledge graph. To fully tap into the power of LLMs, technology disclosed herein implements, in some examples, an algorithm to systematically determine dependencies between skills and then to construct a knowledge graph based on those dependencies. Advantageously, the technology disclosed herein implements LLMs in a targeted way to optimize computer resource usage and efficiency.

Creating graphs using human experts is tedious, slow, and expensive, which limits the ability to produce knowledge graphs at scale and to modify knowledge graphs. Rules-base software systems programmed to generate quality knowledge graphs (e.g., using conditional rules to determine relationships) are impractical given the number of variables in source materials. Leveraging LLMs as proposed herein enables the technology disclosed herein to optimize computer resource usage, efficiency, as well as accuracy and customizability, which further saves time and money. The technology disclosed herein thus advantageously enables the construction of textbook-specific knowledge graphs (as opposed to settling for one-size-fits all solution as provided by other methods). The technology disclosed herein aims to leverage personalized learner models based upon knowledge graphs to personalize tutoring, not only as regular practice throughout a course but also to customize study recommendations to students as they prepare for specific exams. The technology disclosed herein provides for knowledge graphs that enable learner proficiencies to be modeled in more precise ways and thus to personalize recommendations to students. Further, the technology described herein includes, at least in some examples, systems, methods, software, and/or media to generate knowledge graphs using one or more LLMs where the resulting knowledge graphs are generated more quickly (less computer processing time), with less computer and network resources, with less power consumption, and with better accuracy than a software system with an unstructured use of an LLM to create a knowledge graph or with a non-LLM rules-based approach.

One configuration may provide a system. The system may include a processing system including one or more electronic processors. The processing system may be configured to receive electronic content that includes a plurality of content portions, where the plurality of content portions are arranged within the electronic content in a sequential order. The processing system may be configured to identify a plurality of nodes for the electronic content, where each of the plurality of nodes corresponds to one of the plurality of content portions. The processing system may be configured to determine, from the plurality of nodes, a plurality of node pairings based on the sequential order of the electronic content. The processing system may be configured to determine, using a large language model (LLM), a metric for each of the plurality of node pairings, where the metric indicates a respective degree of dependency associated with the corresponding node pairing. The processing system may be configured to generate a graphical representation of the electronic content based on the metric for each of the plurality of node pairings, where the graphical representation indicates relationships between the plurality of content portions of the electronic content.

Another configuration may provide a method. The method may include receiving, with a processing system including one or more electronic processors, a first electronic content including a plurality of content portions that are arranged within the first electronic content in a sequence. The method may include generating, with the processing system, a plurality of nodes for the first electronic content, where each node of the plurality of nodes corresponds to one of the plurality of content portions of the first electronic content. The method may include determining, with the processing system, a plurality of node pairings from the plurality of nodes. The method may include executing, with the processing system, using a large language model (LLM), a first LLM query to determine a metric for each of the plurality of node pairings, where the metric indicates a degree of dependency for a respective node pairing of the plurality of node pairings. The method may include receiving, with the processing system, a response to the first LLM query, where the response indicates the metric for each of the plurality of node pairings. The method may include generating, with the processing system, a graphical representation based on the metric for each of the plurality of node pairings, where the graphical representation indicates requisite relationships between the plurality of content portions of the first electronic content.

Yet another configuration may provide a non-transitory, computer-readable medium storing instructions that, when executed by an electronic processor, perform a set of functions. The set of functions may include receiving electronic content that includes a plurality of content portions arranged within the electronic content in a sequential order, where the plurality of content portions includes a first content portion pertaining to a first topic and a second content portion pertaining to a second topic. The set of functions may include identifying a plurality of nodes for the electronic content, where the plurality of nodes includes a first node representing a first content portion of the plurality of content portions and a second node representing a second content portion of the plurality of content portions. The set of functions may include determining, from the plurality of nodes, a plurality of node pairings based on the sequential order of the electronic content, where the plurality of node pairings includes a first node pairing including the first node and the second node. The set of functions may include determining, using a large language model (LLM), a plurality of metrics based on the plurality of node pairings, where the plurality of metrics includes a first metric for the first node pairing, where the first metric indicates a requisite relationship between the first topic and the second topic. The set of functions may include generating a graphical representation for the electronic content based on the plurality of metrics, where the graphical representation indicates the requisite relationship between the first topic and the second topic such that the graphical representation indicates that the first topic is a prerequisite to the second topic.

This Summary and the Abstract are provided to introduce a selection of concepts in a simplified form that are further described below in the Detailed Description. The Summary and the Abstract are not intended to identify key features or essential features of the claimed subject matter, nor are they intended to be used as an aid in determining the scope of the claimed subject matter.

### BRIEF DESCRIPTION OF THE DRAWINGS

The following drawings are provided to help illustrate various features of examples of the disclosure and are not intended to limit the scope of the disclosure or exclude alternative implementations.

FIG. 1 schematically illustrates a system for generating a knowledge graph using LLM(s) in accordance with some configurations.

FIG. 2 schematically illustrates a server included in the system of FIG. 1 in accordance with some configurations.

FIG. 3 is a flowchart illustrating an example method to generate a knowledge graph in accordance with some configurations.

FIG. 4 illustrates an example graphical representation in accordance with some configurations.

FIG. 5 illustrates an example matrix according to some configurations.

FIG. 6 illustrates another example matrix according to some configurations.

FIG. 7 illustrates another example graphical representation in accordance with some configurations.

### DETAILED DESCRIPTION OF THE PRESENT DISCLOSURE

The disclosed technology is not limited in its application to the details of construction and the arrangement of components set forth in the following description or illustrated in the following drawings. Other examples of the disclosed technology are possible and examples described and/or illustrated here are capable of being practiced or of being carried out in various ways. The terminology in this document is used for the purpose of description and should not be regarded as limiting. Words such as “including,” “comprising,” and “having” and variations thereof as used herein are meant to encompass the items listed thereafter, equivalents thereof, as well as additional items.

A plurality of hardware and software-based devices, as well as a plurality of different structural components can be used to implement the disclosed technology. In addition, examples of the disclosed technology can include hardware, software, and electronic components or modules that, for purposes of discussion, can be illustrated and described as if the majority of the components were implemented solely in hardware. However, in at least one example, the electronic based aspects of the disclosed technology can be implemented in software (for example, stored on non-transitory computer-readable medium) executable by one or more electronic processors. Although certain drawings illustrate hardware and software located within particular devices, these depictions are for illustrative purposes only. In some examples, the illustrated components can be combined or divided into separate software, firmware, hardware, or combinations thereof. As one example, instead of being located within and performed by a single electronic processor, logic and processing can be distributed among multiple electronic processors. Regardless of how they are combined or divided, hardware and software components can be located on the same computing device or can be distributed among different computing devices connected by one or more networks or other suitable communication links.

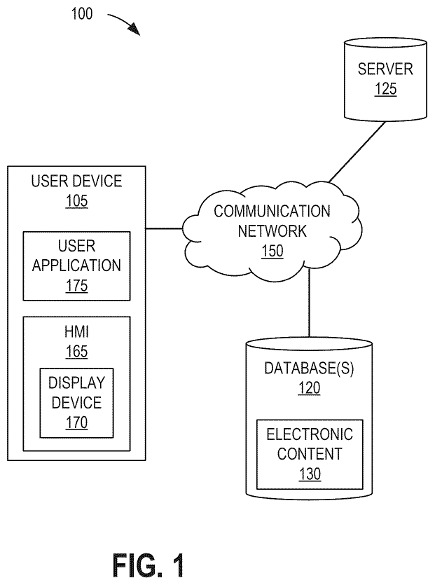

FIG. 1 illustrates a system 100 for developing and implementing knowledge graphs using LLM(s) described herein according to some configurations. In the illustrated example, the system 100 includes a user device 105, one or more databases 120, and a server 125. In some configurations, the system 100 includes fewer, additional, or different components than illustrated in FIG. 1 in different configurations. As one example, the system 100 may include multiple user devices 105, multiple databases 120, multiple servers 125, or a combination thereof. As another example, one or more components of the system 100 may be combined into a single device. For instance, in some examples, the database(s) 120 may be combined into the server 125 such that the server 125 stores electronic content 130 of the database(s) 120. As yet another example, in some configurations, the server 125 and the user device 105 may be combined such that the user device 105 may perform the functionality (or a portion thereof) described herein as being performed by the server 125.

The user device 105, the database(s) 120, and the server 125 may communicate over one or more wired or wireless communication networks 150. Portions of the communication networks 150 may be implemented using a wide area network (“WAN”), such as the Internet, a local area network (“LAN”), such as a Bluetooth™ network or Wi-Fi, and combinations or derivatives thereof. Alternatively, or in addition, in some configurations, components of the system 100 communicate directly as compared to through the communication network 150. Also, in some configurations, the components of the system 100 may communicate through one or more intermediary devices not illustrated in FIG. 1.

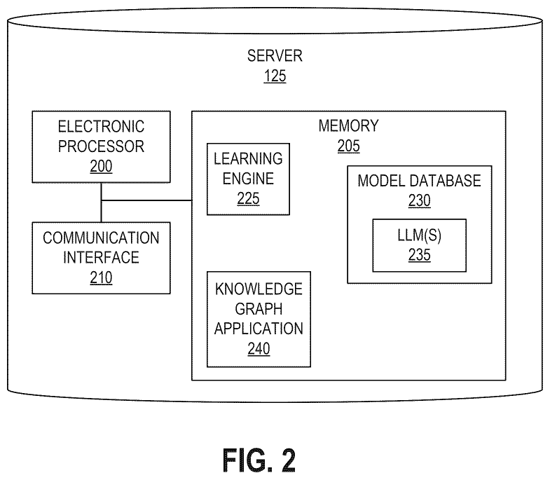

The server 125 may be a computing device. FIG. 2 schematically illustrates an example server 125 according to some configurations. As illustrated in FIG. 2, the server 125 includes an electronic processor 200, a memory 205, and a communication interface 210. The electronic processor 200, the memory 205, and the communication interface 210 may communicate wirelessly, over one or more communication lines or buses, or a combination thereof. The server 125 may include additional, different, or fewer components than those illustrated in FIG. 2 in various configurations. The server 125 may perform additional or different functionality than the functionality described herein. Also, the functionality (or a portion thereof) described herein as being performed by the server 125 may be performed by another component (e.g., the user device 105, another component of the system 100, or a combination thereof), distributed among multiple devices (e.g., as part of a cloud service or cloud-computing environment), combined with another component (e.g., the user device 105, another component of the system 100, or a combination thereof), or a combination thereof.

The communication interface 210 may include a transceiver that communicates with the database(s) 120, the user device 105, or a combination thereof over the communication network 150 and, optionally, one or more other communication networks or connections. The electronic processor 200 includes one or more processors (e.g., one or more microprocessors, one or more application-specific integrated circuits (ASICs), and/or one or more other suitable electronic device for processing data), and the memory 205 includes a non-transitory, computer-readable storage medium. The electronic processor 200 is configured to retrieve instructions and data from the memory 205 and execute the instructions.

As illustrated in FIG. 2, the memory 205 may store a learning engine 225 and a model database 230. In some configurations, the learning engine 225 develops one or more models using one or more machine learning functions. Machine learning functions are generally functions that allow a computer application to learn without being explicitly programmed. In particular, the learning engine 225 is configured to develop an algorithm or model based on training data. As one example, to perform supervised learning, the training data includes example inputs and corresponding desired (for example, actual) outputs, and the learning engine 225 progressively develops a model that maps inputs to the outputs included in the training data. As another example, to perform self-supervised learning (SSL), a model is trained on a task using the data itself to generate supervisory signals (e.g., unlabeled training data), rather than relying on, e.g., external labels provided by a user (e.g., labeled training data). As yet another example, to perform semi-supervised learning, the training data may include desired output values for a subset of the training data (e.g., labeled training data) while the remaining training data may be unlabeled or imprecisely labeled (e.g., unlabeled training data). Machine learning performed by the learning engine 225 may be performed using various types of methods and mechanisms including but not limited to decision tree learning, association rule learning, artificial neural networks, inductive logic programming, support vector machines, clustering, Bayesian networks, reinforcement learning, representation learning, similarity and metric learning, sparse dictionary learning, and genetic algorithms. These approaches allow the learning engine 225 to ingest, parse, and understand data and progressively refine models.

Alternatively, or in addition, in some configurations, the learning engine 225 may generate (or otherwise develop) one or more additional artificial intelligence (AI) or machine learning models to perform the functionality (or a portion thereof) as described herein. For example, in some configurations, the learning engine 225 may generate one or more models configured to generate (or otherwise identify) an identifier (or summary) for a node or content component associated with the electronic content 130, determine (or otherwise assign) a degree of dependency for a node pairing (e.g., determine a strength of a prerequisite-postrequisite relationship between two nodes) associated with the electronic content 130, etc., as described in greater detail herein.

Models generated by the learning engine 225 can be stored in the model database 230. As illustrated in FIG. 2, the model database 230 may be included in the memory 205 of the server 125. It should be understood, however, that, in some configurations, the model database 230 may be included in one or more separate devices accessible by the server 125 of FIG. 2 (including a remote database, and the like).

As described in greater detail herein, in some configurations, the technology disclosed herein may utilize or implement one or more LLMs as part of developing and implementing a knowledge graph, based on, e.g., the electronic content 130, representing relationships (e.g., one or more prerequisite-postrequisite relationships) between concepts and skills, such as, e.g., with respect to generation of identifiers (or summaries) for nodes representing content portions or segments of the electronic content 130, determination of metrics representing a degree of dependency between node parings enumerated for the electronic content 130, etc. Accordingly, in some configurations, the learning engine 225 may develop one or more LLMs 235. Generally, the LLM 235 may include a deep AI or machine learning model that can comprehend and generate human language text. For instance, the LLM 235 may be configured to determine meanings (or context) from a sequence of words and understand relationships between those words and, ultimately, perform a task based on that understanding. For instance, the LLM 235 may perform a variety of natural language processing (“NLP”) related tasks to produce content based on input prompts in human language. Such tasks may include answering questions (e.g., responding to a user query), translating text, text generation, content summary, sentiment analysis, entity extraction, entity or concept mapping or correlations, dependency relationship determination and analysis, etc.

The LLM(s) 235 may be an artificial neural network that is trained using self-supervised learning, semi-supervised learning, or a combination thereof. Accordingly, in some configurations, the learning engine 225 may develop artificial neural networks using self-supervised learning, semi-supervised learning, or a combination thereof. In such configurations, the training data used by the learning engine 225 may be a large corpus of data. As illustrated in FIG. 2, the LLM(s) 235 may be stored in the model database 230 of the server 125. It should be understood, however, that, in some configurations, the LLM(s) 235 may be included in one or more separate devices accessible by the server 125 of FIG. 2 (including a remote database, and the like). In some configurations, the LLM(s) 235 may be trained (or retrained) using feedback data (as training data), which may be utilized to retrain or update the LLM(s) 235 or other AI or machine learning models described herein. In some examples, one or more of the LLM(s) 235 may be a commercially available LLM.

As illustrated in FIG. 2, the memory 205 may include a knowledge graph application 240 (referred to herein as “the application 240”). The application 240 is a software application executable by the electronic processor 200 in the example illustrated and as specifically discussed below, although a similarly purposed module can be implemented in other ways in other examples. In some configurations, the application 240 may be a dedicated software application locally stored in the memory 205 of the server 125. As described in greater detail herein, the application 240 (when executed by the electronic processor 200) may enable or facilitate the skill proficiency framework described herein.

The memory 205 may include additional, different, or fewer components in different configurations. Alternatively, or in addition, in some configurations, one or more components of the memory 205 may be combined into a single component, distributed among multiple components, or the like. Alternatively, or in addition, in some configurations, one or more components of the memory 205 may be stored remotely from the server 125, or, in a remote database, another server, a remote user device, an external storage device, or the like.

Returning to FIG. 1, the system 100 may include the database(s) 120. Although not illustrated in FIG. 1, the database(s) 120 may include similar components as the server 125, such as electronic processor (for example, a microprocessor, an ASIC, or another suitable electronic device), a memory (for example, a non-transitory, computer-readable storage medium), a communication interface, such as a transceiver, for communicating over the communication network 150 and, optionally, one or more additional communication networks or connections, and one or more human machine interfaces.

The database(s) 120 may store (or otherwise include) the electronic content 130. The electronic content 130 may include various media types or formats. For instance, the electronic content 130 may include one or more videos, audios, images, documents, text, etc. As one example, the electronic content 130 may include an electronic document (also referred to herein as an electronic files), including, e.g., a word processing file, a processing file, a spreadsheet file, a presentation file, an electronic correspondence (e.g., email, multimedia messages, etc.), etc. As another example, the electronic content 130 may include audio files, including, e.g., an MP3 file, a WAV file, etc. As yet another example, the electronic content 130 may include video files, including, e.g., an MP4 file, a MOV file, etc. As yet another example, the electronic content 130 may include image files, including, e.g., a JPEG file, a TIFF file, a GIF, a PDF file, etc.

In some configurations, the electronic content 130 may include data or information pertaining to one or more concepts, skills, topics or learning objectives. For instance, in some configurations, the electronic content 130 may be utilized as a teaching aid or educational resource for acquiring a proficiency with respect to an associated learning objective (e.g., learning Biology, sign language, Spanish, etc.). As one example, the electronic content 130 may include one or more electronic textbooks. As another example, the electronic content 130 may be a recording of a lecture or presentation of the electronic content 130 (e.g., an audio recording, a video recording, etc.). As yet another example, the electronic content 130 may be a transcript of a lecture or presentation of the electronic content 130.

In some configurations, the electronic content 130 may be aggregated from a plurality of sources. For instance, in some configurations, the electronic content 130 may be a collection of electronic content 130, where the collection of electronic content 130 may be related to various learning objectives, be of various media types or formats, etc. In some examples, the electronic content 130 may include open educational resource content (e.g., sourced from an open educational resource). As one example, the electronic content 130 may include an electronic Biology textbook, an electronic Physics textbook, and an audio recording of a Theology lecture.

In some configurations, the electronic content 130 may include one or more content components or portions. As used herein, content component or content portion may refer to the data or information included within the electronic content 130. For instance, the data or information included within the electronic content 130 may be segmented or otherwise divided into various component parts (or content portions) such that each content portion of the electronic content 130 includes a subset of data or information of the electronic content 130. In some examples, a content portion may include data or information specific to a particular topic or learning objective. In some examples, the electronic content 130 may include metadata or other corresponding descriptive data that identifies content components or portions of the electronic content 130 (e.g., a table of contents, an index, or the like).

The content portions of the electronic content 130 may be arranged within the electronic content 130 in a sequential order (or hierarchy). In some examples, the sequential order of the content portions of the electronic content 130 may indicate (or otherwise define) requisite relationships between various content portions (e.g., prerequisite-postrequisite relationship between content portions). For instance, when the electronic content 130 includes a first content portion and a second content portion subsequent to the first content portion, the sequential order may indicate that the first content portion as a prerequisite to the second content portion, while the second content portion may be a postrequisite to the first content portion. However, in some examples, even though a second content portion occurs subsequent to the first content portion, the first content portion is not a prerequisite to the second content portion. Regardless, in some cases, it may be presumed that a content portion subsequent to another content portion, for sequentially ordered content portions, is not a prerequisite to the latter content portion due to the sequential order.

As one example, when the electronic content 130 is an electronic textbook, each chapter of the electronic textbook may be a content portion (e.g., a first chapter may be a first content portion, a second chapter may be a second content portion, etc.). The electronic content 130 may include a table of contents that identifies these content portions of the electronic textbook. As another example, when the electronic content 130 is a slideshow presentation, each slide included in the slideshow may be a content portion (e.g., a first slide may be a first content portion, a second slide may be a second content portion, etc.). As yet another example, when the electronic content 130 is a transcript of a lecture or presentation, the transcript may be segmented into various component parts, where each component part may be a content portion (e.g., a first component part may be a first content portion, a second component part may be a second content portion, etc.). As yet another example, when the electronic content 130 is an electronic textbook, each section of the electronic textbook may be a content portion (e.g., a first section of a first chapter may be a first content portion, a second section of the first chapter may be a second content portion, a first section of a second chapter may be a third content portion, etc.). As used herein, a section of an electronic textbook may be included within a chapter of the electronic textbook, where the chapter may be made up of one or more sections. As still another example, when the electronic content 130 is an electronic textbook, each problem or question (e.g., sample problem, practice problem, etc.) included in the electronic textbook may be a content portion (e.g., a first problem or question may be a first content portion, a second problem or question may be a second content portion, etc.).

In some configurations, the electronic content 130 may include content portions of varying types, such that the electronic content 130 may be made up of a plurality of content portion types (e.g., chapters, sections, slides, problems, questions, images, etc.). As one example, when the electronic content 130 is an electronic textbook, the content portions of the electronic textbook may include a content portion for one or more sections of the electronic textbook, a content portion for one or more problems or questions included in the electronic textbook, a content portion for one or more chapters of the electronic textbook, etc.

The system 100 may also include the user device 105. The user device 105 may include a computing device, such as a desktop computer, a laptop computer, a tablet computer, a terminal, a smart telephone, a smart television, a smart wearable, or another suitable computing device that interfaces with a user. Although not illustrated in FIG. 1, the user device 105 may include similar components as the server 125, such as electronic processor (for example, a microprocessor, an ASIC, or another suitable electronic device), a memory (for example, a non-transitory, computer-readable storage medium), a communication interface, such as a transceiver, for communicating over the communication network 150 and, optionally, one or more additional communication networks or connections, and one or more human machine interfaces (HMIs). In some configurations, the functionality (or a portion thereof) as described as being performed by the server 125 may be locally performed by the user device 105. Alternatively, or in addition, in some configurations, the user device 105 may perform additional or different functionality than described herein. As one example, in some configurations, the functionality (or a portion thereof) described as being performed by the server 125 may be performed by another component of the system 100, such as, e.g., the user device 105. In such configurations, the user device 105 may store at least one of, e.g., the application 240, the learning engine 225, the model database 230, the LLM(s) 235, or the like.

As illustrated in FIG. 1, the user device 105 may include a human machine interface (“HMI”) 165 for interacting with a user. The HMI 165 may include one or more input devices, one or more output devices, or a combination thereof. Accordingly, in some configurations, the HMI 165 allows a user to interact with (e.g., provide input to and receive output from) the user device 105. For example, the HMI 165 may include a keyboard, a cursor-control device (e.g., a mouse), a touch screen, a scroll ball, a mechanical button, a display device (e.g., a liquid crystal display (“LCD”)), a printer, a speaker, a microphone, or a combination thereof. In the illustrated example of FIG. 1, the HMI 165 includes a display device 170. The display device 170 may be included in the same housing as the user device 105 or may communicate with the user device 105 over one or more wired or wireless connections. As one example, the display device 170 may be a touchscreen included in a laptop computer, a tablet computer, or a smart telephone. As another example, the display device 170 may be a monitor, a television, or a projector coupled to a terminal, desktop computer, or the like via one or more cables.

As illustrated in FIG. 1, the user device 105 may include a user application 175. The user application 175 is a software application executable by an electronic processor in the example illustrated and as specifically discussed below, although a similarly purposed module can be implemented in other ways in other examples. For example, the user application 175 may include a set of instructions, tangibly embodied on one or more non-transitory computer-readable media, such that a processor device of the user device 105 retrieve and execute the set of instructions to implement the functionality of the user application 175 described herein. In some configurations, the user application 175 may be a dedicated software application locally stored in a memory of the user device 105. In some configurations, the user application 175 may be a web-based software application remotely stored and executed by a remote processing device, but accessible by the user device 105 via a web browser, virtual desktop, or other interface. In some configurations, the user application 175 (when executed by an electronic processor) may enable or facilitate user interaction with the knowledge graph(s) described herein. For instance, in some examples, a user may interact with the knowledge graph(s) (e.g., via the user application 175) to obtain an accurate assessment of progress towards a learning objective, implement or develop more efficient study plans, access an all-in-one solution to help complete learning tasks (e.g., homework assignments), obtain a study guide for exam preparation, etc. As described in greater detail herein, in some configurations, a user may interact the user application 175 (e.g., via one or more user interfaces provided to the user by the user application 175) by viewing and interacting with the knowledge graph(s) or other content generated based on the knowledge graph(s) described herein.

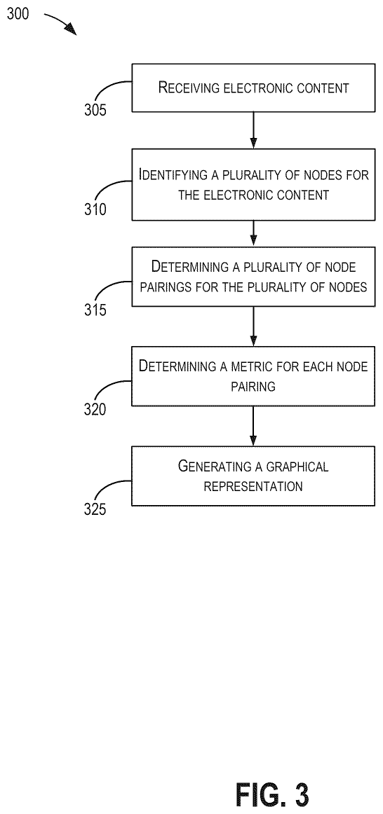

FIG. 3 illustrates a flowchart of an example method 300 to generate knowledge graphs using LLMs according to some configurations. The method 300 is described as being performed by the server 125 and, in particular, the application 240 as executed by the electronic processor 200. However, as noted above, the functionality described with respect to the method 300 may be performed by other devices, such as, e.g., the user device 105, or distributed among a plurality of devices, such as a plurality of servers included in a cloud service.

As illustrated in FIG. 3, the method 300 may include receiving (or otherwise retrieving), with the electronic processor 200, the electronic content 130 (at block 305). As described herein, the electronic content 130 may be stored in the database(s) 120. Accordingly, in some configurations, the electronic processor 200 may receive the electronic content 130 from the database(s) 120. Alternatively, or in addition, in some configurations, the electronic content 130 may be locally stored in the memory 205. In such configurations, the electronic processor 200 may receive (or retrieve) the electronic content 130 from the memory 205. In some examples, the electronic processor 200 may receive (or otherwise retrieve) the electronic content 130 responsive to receiving a request to generate or implement a knowledge graph with respect to the electronic content 130. Alternatively, or in addition, the electronic processor 200 may receive (or retrieve) the electronic content 130 responsive to detecting that new content was added to the database(s) 120 (e.g., new electronic content). In some examples, the electronic processor 200 may receive a notification of new electronic content or may monitor the database(s) 120 for new electronic content.

The electronic processor 200 may identify a plurality of nodes for the electronic content 130 (at block 310). A node for the electronic content 130 may correspond to (or represent) a content portion of the electronic content 130. In some examples, the plurality of nodes includes a node for each content portion of the electronic content 130. For example, when the electronic content 130 is a textbook having 30 chapters (e.g., the content portions of the electronic content 130), the electronic processor 200 may identify a node for each chapter of the textbook (e.g., 30 nodes).

In some configurations, the electronic processor 200 may determine a granularity level (or granularity setting) at which to identify nodes for the electronic content 130. A granularity level or setting may refer to a quantity of nodes to be determined or identified with respect to the electronic content 130.

In some configurations, the granularity setting may specify a particular number of nodes to be determined or identified for the electronic content 130, such as, e.g., a minimum number of nodes, a maximum number of nodes, a total number of nodes, etc. In such configurations, the electronic processor 200 may identify the plurality of nodes such that the plurality of nodes complies with (or otherwise is in accordance with) the number of nodes specified by the granularity setting. As one example, when the granularity setting is 15 nodes to be identified, the electronic processor 200 may identify 15 nodes for the electronic content 130.

Alternatively, or in addition, in some configurations, the granularity setting may specify a numerical window or range of nodes that a total number of nodes to be identified for the electronic content 130 should fall within. For example, the granularity setting may indicate a range that the total number of nodes to be identified for the electronic content 130 should fall within (e.g., between 10-15 nodes). In such configurations, the electronic processor 200 may identify the plurality of nodes such that the plurality of nodes complies with (or otherwise is in accordance with) the numerical window or range of nodes specified by the granularity setting. As one example, when the granularity setting is 15-20 nodes, the electronic processor 200 may identify 17 nodes (or another number of nodes falling within 15-20 nodes).

Alternatively, or in addition, in some configurations, the granularity setting may establish a property of the electronic content 130 that triggers identification of a node. For example, the granularity setting may identify a property of the electronic content 130 such that a node is identified for each occurrence of that property of the electronic content 130. A property of the electronic content 130 may include a structural element of the electronic content 130 (e.g., a preexisting element or property), such as, e.g., a chapter, a section, a subsection, a practice problem, etc. As one example, the granularity setting may indicate that a node should be identified for each chapter of the electronic content 130 (e.g., a chapter-level granularity). As another example, the granularity setting may indicate that a node should be identified for each subsection of each chapter of the electronic content 130 (e.g., a subsection-level granularity). As yet another example, the granularity setting may indicate that a node should be identified for each practice problem included in the electronic content 130 (e.g., a problem-level granularity). Alternatively, or in addition, the property of the electronic content 130 may include a topic or a subtopic (or learning objective) of the electronic content. As one example, the granularity setting may indicate that a node should be identified for each topic or subtopic included in the electronic content 130 (e.g., a topic-level granularity).

In instances where the granularity setting does not define an absolute number of nodes to be identified for the electronic content 130, the electronic processor 200 may ultimately determine how many nodes to identify based on one or more additional factors or considerations. For example, the electronic content 130 may identify the nodes based on a property of the electronic content 130 (e.g., chapters, sections, subsections, etc.) as well as the granularity setting. For instance, when the electronic content 130 includes 16 chapters and the granularity setting specifies a window of 15-20 nodes, the electronic processor 200 may identify 16 nodes for the electronic content 130, where each node corresponds to a chapter of the electronic content 130.

Different use cases may implement differing degrees of granularity. The degree of granularity in which nodes are identified may impact how detailed a resulting knowledge graph will be. For instance, a higher degree of granularity may result in a larger number of nodes to be identified for the electronic content 130, which, ultimately, may result in a more detailed knowledge graph (as the resulting knowledge graph will include an increased number of nodes). Further, a lower degree of granularity may result in a smaller number of nodes to be identified for the electronic content 130, which, ultimately, may result in a less detailed knowledge graph (as the resulting knowledge graph will include a reduced number of nodes). As such, based on a desired degree of granularity, a resulting knowledge graph may be specifically tailored to a particular use case (or a particular user).

In some configurations, a user may specify a level of detail desired for a knowledge graph. For instance, in some examples, a user may provide user input associated with a degree of granularity to be used when identifying nodes within the electronic content 130 (also referred to herein as a granularity setting). In some configurations, the user may interact with the user application 175 (via the HMI 165) to provide or otherwise define the granularity setting. The granularity setting may establish a degree of granularity at which nodes are to be identified for the electronic content 130. Accordingly, in some configurations, the electronic processor 200 may receive a user input including, e.g., a granularity setting. The electronic processor 200 may determine the granularity setting based on the user input. The electronic processor 200 may identify the plurality of nodes for the electronic content 130 (e.g., at block 310) based on the granularity setting (e.g., such that the electronic processor 200 identifies the plurality of nodes in accordance with the granularity setting).

In some configurations, the electronic processor 200 may generate (or otherwise determine) an identifier for each node of the plurality of nodes. An identifier may be based on a topic (or learning objective) associated with the content portion of the corresponding node. The identifier may be a description or summary of the content portion that the node represents or corresponds to. As one example, when the node represents a content portion related to how to multiply fractions, the identifier may be “Multiplication of Fractions.” In some examples, the identifier further includes a brief description or summary (e.g., a few sentences, a paragraph, or few paragraphs of text) that is descriptive of the content portion.

In some examples, the electronic processor 200 may utilize the LLM(s) 235 to generate an identifier for a node. For instance, the electronic processor 200 may execute an LLM query that includes the data or information included within a content portion and a request that the LLM(s) 235 process the data or information and generate an identifier for that content portion. The electronic processor 200 may receive a response from the LLM(s) 235, where the response may include the identifier generated for the content portion.

Alternatively, or in addition, in some examples, the electronic processor 200 may extract an identifier for a node from the electronic content 130. In such instances, the electronic processor 200 may extract a preexisting identifier from the electronic content 130, where the content portion is identified by the preexisting identifier in the electronic content 130. For example, the electronic processor 200 may extract the identifier for the node from a table of contents of the electronic content 130, where the identifier for the node is the text used in the table of contents for the content portion represented by the node. As another example, when the content portion is a chapter of an electronic textbook, the electronic processor 200 may extract a title or synopses of the chapter and utilize the title and/or synopses of the chapter as the identifier for the node. Accordingly, in some configurations, the electronic processor 200 may extract the identifier from a table of contents, an end-of-section synopses, an end-of-chapter synopses, etc.

The electronic processor 200 may determine one or more node pairings (at block 315). A node pairing may include two nodes from the plurality of nodes identified for the electronic content 130 (e.g., as identified at block 310). The two nodes included in the node pairing may represent a candidate of content portions (or topics thereof) having a dependency (or a requisite relationship, such as, e.g., a prerequisite-postrequisite relationship).

In some examples, the electronic processor 200 may construct a list of all possible pairs of nodes (e.g., as a plurality of node pairings). In some instances, the electronic processor 200 may construct the list of node pairings in preparation for calls to the LLM(s) 235. In some configurations, the electronic processor 200 may determine a node pairing when a content portion of one node precedes another content portion of another node within the sequential order of the electronic content 130. For instance, in some examples, the plurality of node pairings may be forward node pairings. As one example, a node pairing may include a first node representing a first content portion and a second node representing a second content portion. When the first content portion precedes the second content portion within the sequential order of the electronic content 130 (e.g., the first content portion precedes the second content portion in a table of contents of the electronic content 130), the electronic processor 200 may determine the first node and the second node to form a node pairing (e.g., a forward node pairing).

Authors carefully sequence topics to ensure that postrequisite concepts fall after prerequisite concepts. Accordingly, the technology disclosed herein advantageously takes such sequential structure into consideration to optimize resource usage and efficiency. Accounting for such a sequential structure and eliminating “backward-moving” node pairs, the technology disclosed herein may produce a list of N(N−1)/2 pairs for N nodes. As such, the complexity of the task grows quadratically with respect to the number of nodes.

Accordingly, in some examples of block 315, to determine the plurality of node pairings for the plurality of nodes, the electronic processor 200 may determine a plurality of forward node pairings for the plurality of nodes identified in block 310, where the plurality of nodes have a sequential order, and where the plurality of forward node pairings does not include (or excludes) backward-moving node pairs. Thus, the resulting plurality of node pairings determined in block 315 may be less than a total number of possible node pairings and, as noted, may be a list of N(N−1)/2 node pairings (for N total nodes).

The electronic processor 200 may determine a metric for each node pairing (at block 320). The metric may indicate a respective degree (or strength) of dependency (or requisite relationship) associated with the corresponding node pairing. In some examples, the electronic processor 200 may implement (or otherwise utilize) the LLM(s) 235 to determine the metric for each node pairing. For each pair of candidates, the electronic processor 200 may call the LLM(s) 235 to determine the strength of the prerequisite-postrequisite relationship between the two nodes of the node pairing. For instance, in some configurations, the electronic processor 200 may execute, with respect to the LLM(s) 235, an LLM query to determine a metric for a node pairing (e.g., strength of the prerequisite-postrequisite relationship between the two nodes of the node pairing). For example, the LLM query may include a prompt or request to the LLM to generate a metric for a node pairing (e.g., a score, rating, or other assessment of a requisite relationship between two nodes). The prompt or request may also include the identifier of each node in the node pairing, as well as may specify a form or format of the requested metric (e.g., a score between 1-10 where 10 indicates a stronger requisite relationship and 1 indicates a weaker requisite relationship). The electronic processor 200 may receive a response to the LLM query, which may include (or otherwise indicate) the metric for the node pairing (e.g., strength of the prerequisite-postrequisite relationship between the two nodes of the node pairing).

In some configurations, to further assist the LLM(s) 235 in performing this task, intermediate questions may be queried, including requesting the LLM(s) 235 to specify precisely which concepts (also referred to herein as topics) are and are not prerequisites that create dependencies between the nodes. Just as the technology disclosed herein assists the LLM(s) 235 by breaking the candidate nodes down into simple pairs (e.g., the forward node pairing(s)), the technology disclosed herein may further assist the LLM(s) 235 by querying intermediate questions (e.g., “chain of thought” steps) to guide the LLM(s) 235 toward the eventual, quantitative indication of dependency for a corresponding node pairing (e.g., a score or rating of the prerequisite-postrequisite dependency on, e.g., a scale from 0 to 10). In effect, this step populates half of a matrix (upper or lower triangular) to capture all of the dependencies between all the forward-looking candidate pairs of nodes.

In some configurations, the electronic processor 200 may perform a secondary metric determination to, e.g., validate or verify the metric for each node pairing (e.g., as determined at block 320). For instance, in some configurations, the electronic processor 200 may execute, with respect to a second, different LLM, a second LLM query to determine the metric for the plurality of node pairings, and receive a response from the second, different LLM, where the response may indicate a secondary metric for the plurality of node pairings. The electronic processor 200 may compare the metrics associated with the first LLM and the metrics associated with the second LLM in order to validate or verify the strength of the dependencies of the node pairing(s). For instance, a first LLM may return a first score or rating of a prerequisite-postrequisite dependency for a first node pairing and a second LLM may return a second, different score or rating of the prerequisite-postrequisite dependency for the first node pairing. When the first score and the second score are substantially similar (e.g., within an acceptable error or tolerance range), the electronic processor 200 may validate or verify the score (or metric). In some configurations, the electronic processor 200 may average the first score and the second score to determine an average score, which may be utilized by the technology disclosed herein when generating a corresponding knowledge graph. In some examples, the electronic processor 200 may average the first score and the second score when the first score and the second score are not substantially similar.

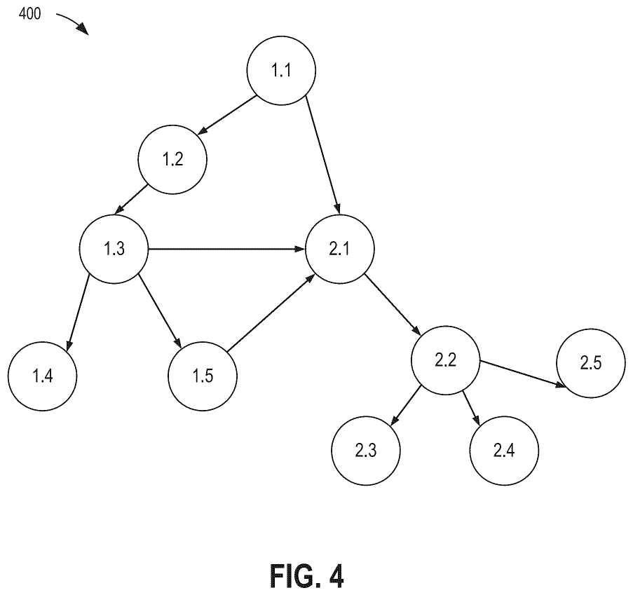

The electronic processor 200 may generate a graphical representation of the electronic content 130 (e.g., a knowledge graph) (at block 325). In some configurations, the electronic processor 200 may generate the graphical representation based on the metrics determined for each of the node pairings (e.g., as determined at block 320). The graphical representation may indicate relationships between the content portions of the electronic content 130 (e.g., also referred to herein as requisite relationships, such as, e.g., prerequisite-postrequisite relationships). In some configurations, the graphical representation may be a graph, such as, e.g., a directed acyclic graph, an acyclic digraph, etc. For example, FIG. 4 illustrates an example graph 400 in accordance with some configurations. As illustrated in FIG. 4, the graph 400 may include a plurality of nodes and a plurality of edges connecting the nodes. In some configurations, the edges may represent a requisite relationship (e.g., a prerequisite-postrequisite relationship) between two nodes, as illustrated in FIG. 4. The graphical representation generated in block 325 is a graph, which may be visually depicted (see, e.g., FIG. 4), stored (e.g., in the memory 205), and/or transmitted to another device (e.g., to the user device 105 for further storage or display thereon).

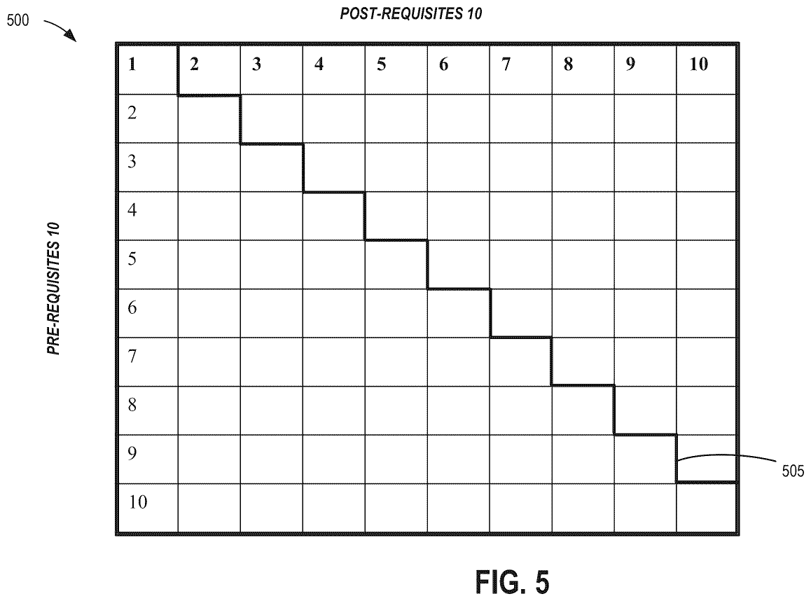

In some configurations, the electronic processor 200 may generate a matrix based on the metrics for the node pairings and generate the graphical representation based on the matrix. For example, FIG. 5 illustrates an example matrix 500 according to some configurations. In the example of FIG. 5, the matrix 500 includes 10 concepts organized into the matrix 500 as 10 prerequisite concepts (positioned in the matrix 500 vertically) and 10 postrequisite concepts (positioned in the matrix 500 horizontally). The matrix 500 may indicate potential requisite relationships between the 10 concepts (or topics). This example results in 45 potential requisite relationships, with each potential requisite relationship having an associated box in the matrix (e.g., boxes 2-1, 3-1, 4-1, 5-1, 6-1, 7-1, 8-1, 9-1, 10-1, 3-2, 4-2, 5-2 . . . 10-2, 4-3, 5-3, 6-3, . . . 10-3, and so on through 10-9, where the first number in each pair indicates horizontal position and the second number indicates vertical position in the matrix). Thus, each box above a diagonal line 505 dividing the matrix 500 represents a potential requisite relationship for the 10 concepts. Here, the 55 boxes below the diagonal line 505 may be excluded from the potential requisite relationships (i.e., they may be included to not be potential requisite relationships). These boxes may be excluded because of a sequential order of the concepts that exists in the underlying electronic content that is the source of the concepts in the matrix 500. That is, the system may presume that a concept that appears later in sequential order of the electronic content will not be a prerequisite of a concept that appears earlier in sequential order of the electronic content, and that a concept cannot be a prerequisite of itself. For example, the system may presume, for example, that concept 2 will not be a prerequisite of concept 1, and concept 8 will not be a prerequisite of concept 4. Thus, the matrix 500 shows 45 potential requisite relationships between the ten concepts.

Each of the 45 potential requisite relationships, each associated with a pair of nodes or concepts, may serve as a node pairing (e.g., may be determined to be a node pairing of the plurality of nodes in block 315 of FIG. 3). As noted, in block 320, a metric may be determined for each node pairing using an LLM. Thus, by excluding the 55 node pairings from requests to an LLM to determine corresponding metrics, the number or size of requests of the LLM to determine metrics for node pairings may be reduced, increasing the efficiency and speed of the system, while reducing the power consumption of the system, to generate a graph relative to a system that uses an LLM to determine metrics for each potential node pairing.

In some examples, the metrics determined for the node pairings may be stored in an array or other data structure, where each element of the array or data structure represents a node pairing and corresponds to a box in a matrix (e.g., like the matrix 500). This array or data structure may be visually illustrated in a matrix, such as, for example, the matrix 500. For example, each of the 45 boxes in FIG. 5 representing a potential requisite relationship may be assigned and include one of the metrics determined in block 320. Accordingly, in some examples, the node pairings and corresponding metrics may be illustrated visually in a matrix such as illustrated in FIG. 5, with a metric shown in each of the 45 boxes.

Thus, whether visually indicated or stored in memory as data in an array or other data structure, the underlying data of the matrix 500, including node pairings and corresponding metrics, may be a triangular matrix of dependency weights (or metrics). Further, the matrix 500 with such weights (or metrics) may be converted into edges on a graph (e.g., the graph 400 of FIG. 4). Whether a particular weight for a node pairing results in an edge in a graph may vary based on the number of concepts, desired size of the graph, and other factors. However, generally, at least in some examples, the higher the metric in a box, the more likely that the box will translate into an edge in the graph showing a requisite relationship between the concepts (nodes) corresponding to the box.

In some examples, the electronic processor 200 may employ an edge threshold to determine whether to create an edge in the resulting graphical representation (or graph) in block 325 of the method 300. The electronic processor 200 may compare the metric of each box of potential node pairing in the matrix 500 to the edge threshold. When the metric of a particular box (i.e., node pairing) is above the edge threshold, the electronic processor 200 may generate an edge between the corresponding node pairing in the graphical representation. When the metric of a particular box (i.e., node pairing) is below the edge threshold, the electronic processor 200 may not generate an edge between the corresponding node pairing in the graphical representation. For example, with reference to FIG. 4, a node pairing of 1.1 and 1.2 is shown with an edge, while a node pairing of 1.4 and 1.5 is shown without an edge. Presuming this technique for edge generation is employed, the presence of an edge and lack of an edge for these pairings, respectively, indicates that a corresponding matrix for the nodes of the graph 400 would have a metric for the node pairing for 1.1 and 1.2 that exceeded the edge threshold, and a metric for the node pairing of 1.4 and 1.5 that was below the edge threshold.

The edge threshold may be, for example, predetermined (e.g., stored in and retrieved by the electronic processor 200 from the memory 205) or received by the electronic processor 200 from the user device 105 (e.g., in response to a user input indicating the edge threshold that is received at the HMI 165). In some examples, the edge threshold is dynamically determined by the electronic processor 200 to obtain a graph with a number of edges in a particular range. For example, generally, by lowering the edge threshold, more edges would result, while increasing the edge threshold would reduce the number of edges. Accordingly, the electronic processor 200 may select an edge threshold that results in a graph with a number of edges in a particular range. The range may be, for example, predetermined (e.g., stored in and retrieved by the electronic processor 200 from the memory 205) or received by the electronic processor 200 from the user device 105 (e.g., in response to a user input indicating the edge threshold that is received at the HMI 165). In some examples, the block 325 is executed iteratively with different edge thresholds selected by the electronic processor 200 for each iteration until the resulting graphical representation has a number of edges within the particular range.

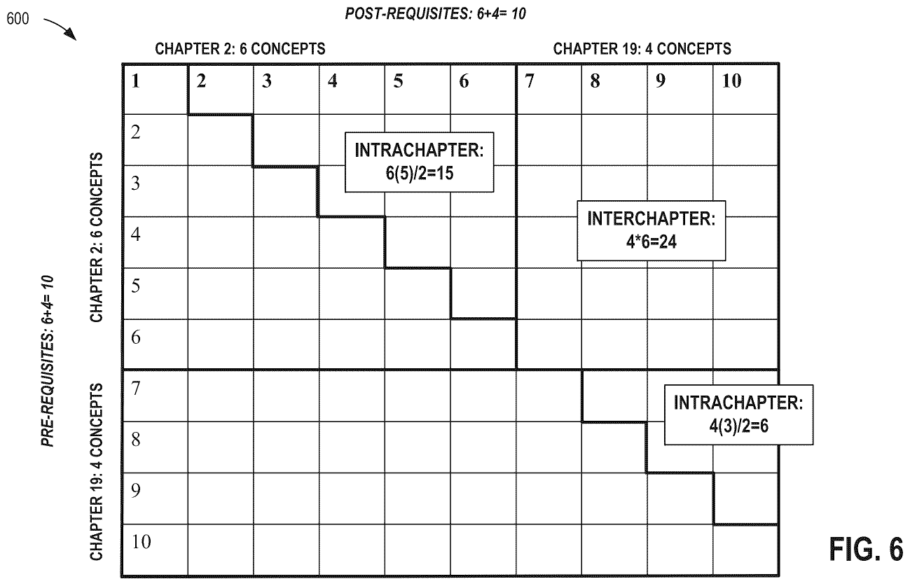

FIG. 6 illustrates another example matrix 600 according to some configurations. As illustrated in FIG. 6, the matrix 600 may indicate requisite relationships with respect to different chapters (e.g., Chapter 19 and Chapter 2) as well as different concepts within each chapter. For instance, Chapter 2 has 6 concepts (or topics), which may result in 6 nodes (one node per concept) and Chapter 19 may have 4 concepts (or topics), which may result in 4 nodes (one node per concept). As illustrated in FIG. 6, the matrix 600 may indicate potential requisite relationships between concepts (or topics) included in the same chapter (potential intrachapter relationships). For instance, the matrix 600 includes potential requisite relationships between the 6 topics included in Chapter 2 and requisite relationships between the 4 topics included in Chapter 19. This example, with 6 topics in Chapter 2, results in fifteen potential intrachapter requisite relationships, with each potential intrachapter requisite relationship having an associated box in the matrix (e.g., boxes 2-1, 3-1, 4-1, 5-1, 6-1, 3-2, 4-2, 5-2, 6-2, 4-3, 5-3, 6-3, 5-4, 6-4, 6-5, where the first number in each pair indicates horizontal position and the second number indicates vertical position in the matrix). An additional six potential intrachapter requisite relationships are illustrated for the 4 concepts of chapter 19. In addition to the potential requisite relationships between concepts included in the same chapter, the matrix 600 also includes potential requisite relationships between the topics of different chapters (e.g., the 6 topics of Chapter 2 and the 4 topics of Chapter 19), which may be referred to as potential interchapter relationships. In this example, 24 potential interchapter requisite relationships are illustrated. Each of the 45 potential requisite relationships, each associated with a pair of nodes or concepts, may serve as a node pairing (e.g., may be determined to be a node pairing of the plurality of nodes in block 315 of FIG. 3). As noted, in block 320, a metric may be determined for each node pairing using an LLM. In some examples, the metrics determined for the node pairings may be stored in an array or other data structure, where each element of the array or data structure represents a node pairing. For example, visually, each of the 45 boxes in FIG. 6 representing a potential requisite relationship may be assigned one of the metrics determined in block 320. Accordingly, in some examples, the node pairings and corresponding metrics may be illustrated visually in a matrix such as illustrated in FIG. 6, with a metric shown in each of the 45 boxes.

Additionally, as previously noted, the electronic processor 200 may take advantage of a sequential order of the concepts that exists in the underlying electronic content that is the source of the concepts in the matrix 600. That is, the electronic processor 200 may presume that a concept that appears later in sequential order of the electronic content will not be a prerequisite of a concept that appears earlier in sequential order of the electronic content, and that a concept cannot be a prerequisite of itself. For example, the electronic processor 200 may presume that concept 2 of Chapter 6 will not be a prerequisite of concept 1 of Chapter 6. Thus, the matrix 600 shows 45 potential requisite relationships between the ten concepts, each being one of the node pairings determined in block 315. The matrix 600 further shows 55 boxes, each representing a pair of concepts, that are not considered potential requisite relationships (see, e.g., box 2-3, 5-8, or 1-1). Thus, the pairs represented by these 55 boxes may be not considered one of the plurality of node pairings in block 315. Again, by excluding these node pairings, the number or size of requests of the LLM to determine metrics for node pairings may be reduced, increasing the efficiency and speed of the server 125, while reducing the power consumption of the server 125, to generate a graph relative to a system that uses an LLM to determine metrics for each potential node pairing.

As noted, in block 320, a metric may be determined for each node pairing by querying an LLM. In some examples, the electronic processor 200 may request that an LLM provide a metric for each potential node pairing using individual requests to the LLM, one for each node pairing. In some examples, the electronic processor 200 may request that an LLM provide a metric for each potential node pairings using one combined request. In still further examples, the electronic processor 200 may divide the potential node pairings into subsets or batches, and request that an LLM provide a metric for each potential node pairing using separate batch requests, one batch request for each subset or batch of potential node pairings. For example, with reference to the matrix 600 of FIG. 6, the electronic processor 200 may generate a first batch request for the intrachapter node pairings of Chapter 2, a second batch request for the intrachapter node pairings of Chapter 19, and a third batch request for the interchapter node pairings of Chapters 2 and 19. Thus, in some examples, the electronic processor 200 may batch node pairings according to chapter and, more particularly, according to intrachapter and interchapter groupings of node pairings. Thus, in some examples, the electronic processor 200 may generate, for each chapter or section of the electronic content 130, a batch request to an LLM to generate a metric for each node pairing for potential intrachapter node pairings of the chapter, and may generate, for each pair of chapters or sections of the electronic content 130, a batch request to an LLM to generate a metric for each node pairing for potential interchapter node pairings of the chapter or section pair.

Using individual requests for each node pairing can increase network traffic, token usage, and time for metric generation (and, ultimately, graph generation). Using one combined request (or particularly large requests) to obtain metrics for each node pairing can exceed LLM processing or output limits. However, using batch requests can balance LLM limits with efficiency (in terms of network traffic, tokens, time, power consumption, etc.), as well as provide a structure or organization to the requests that is more manageable to implement, track, and troubleshoot (e.g., in the event of errors or anomalies).

In some instances, the electronic processor 200 may receive (or otherwise retrieve) a graph setting to be utilized when generating the knowledge graph (e.g., or graphical representation). Different use cases may implement or construct different types of graphs. For example, simple trees promote efficient propagation by limiting every pair of nodes on the graph (or graphical representation) to a single connecting path, whereas multiple connected nodes can complicate propagation logic by expressing more complex patterns of dependency (e.g., paths that diverge and then rejoin). Similarly, for different use cases, a particular number of child nodes associated with a given parent node may be advantageous. Accordingly, in some configurations, the electronic processor 200 may determine a graph setting that establishes a characteristic of the graphical representation. The electronic processor 200 may generate the graphical representation such that the graphical representation is generated in accordance with the graph setting (or characteristic established thereof). In some configurations, the characteristic may include a graph type, a graph structure, a maximum number of child nodes per parent node, etc.

Accordingly, given a triangular matrix of dependency weights and a desired graph typology, the technology disclosed herein may convert those weights and constraints into edges on a graph (e.g., such as the graph 400 of FIG. 4). In some configurations, the technology disclosed herein may implement one or more iteration to test different thresholds and different configurations depending on the desire density and structure of the final knowledge graph (or graphical representation).

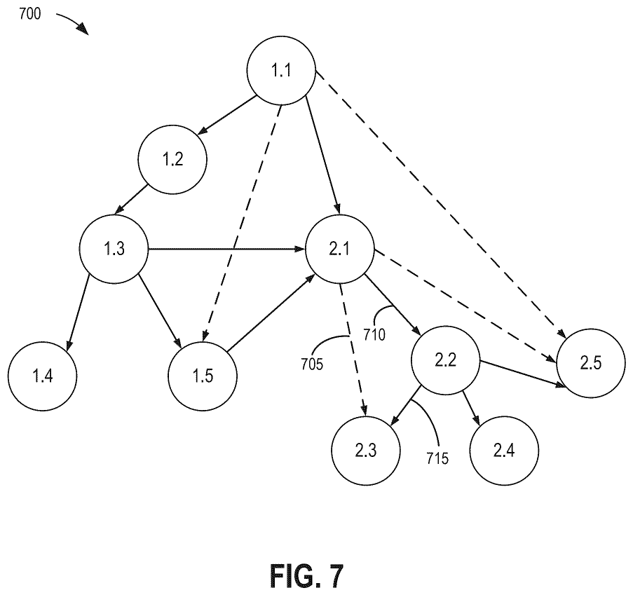

In some configurations, the electronic processor 200 may determine (or otherwise identify) a set of redundant paths within a graphical representation. For example, FIG. 7 illustrates a graph 700 that includes redundant paths in accordance with some configurations. The redundant paths are generally represented in FIG. 7 by dashed arrows. As one example, with reference to FIG. 7, a node pairing that includes node 2.1 and node 2.3 has two paths (e.g., redundant paths). A first path between node 2.1 and node 2.3 includes a first edge 705 (connecting node 2.1 and node 2.3). A second path between node 2.1 and node 2.3 includes a second edge 710 (connecting node 2.1 to node 2.2) and a third edge 715 (connecting node 2.2 to node 2.3). The electronic processor 200 may select one of the redundant paths to be removed. The removal of redundant paths may be referred to as pruning. In some configurations, the electronic processor 200 may select a redundant path for removal based on a quantity of edges included in that path. Following the previous example, the first path includes 1 edge (e.g., the first edge 705) while the second path includes 2 edges (e.g., the second edge 710 and the third edge 715). In some configurations, the electronic processor 200 may remove (or otherwise eliminate) the path with the least number of edges. Following the previous example, the electronic processor 200 may remove the first path (e.g., the first edge 705).

As noted herein, in some configurations, the electronic content 130 may include multiple pieces of content (e.g., a first electronic textbook and a second electronic textbook). For instance, in some configurations, the electronic content 130 may be a collection of data or information from a plurality of data sources (e.g., a collection of electronic content 130). In such instances, the graphical representation may be generated with respect to data or information from a plurality of data sources. Accordingly, in some configurations, the electronic processor 200 may repeat functionality described herein (e.g., as described herein with respect to blocks 305-325) with respect to a collection of data or information from a plurality of data sources (e.g., a first electronic content, a second electronic content, etc.).

As one example, the electronic processor 200 may receive a second electronic content including a one or more second content portions (e.g., as similarly described herein with respect to block 305). The electronic processor 200 may generate a second plurality of nodes for the second electronic content, where each node of the second plurality of nodes corresponds to one of the plurality of second content portions of the second electronic content (e.g., as similarly described herein with respect to block 310). The electronic processor 200 may determine a node pairing based on the first plurality of nodes for the first electronic content or the second plurality of nodes for the second electronic content.

As one example, the node pairing may include a node representing a content portion of the first electronic content and a node representing a content portion of the second electronic content. Following this example, the electronic processor 200 may determine (as the metric) a strength of the dependency between the content portion of the first electronic content and the content portion of the second electronic content, and, ultimately, may generate the graphical representation to indicate the dependency between the content portion of the first electronic content and the content portion of the second electronic content. In such instances, the technology disclosed herein may indicate dependencies (or requisite relationships) across multiple resources (e.g., across multiple electronic textbooks). For instance, in some cases, the technology disclosed herein may provide a recommendation that, if a user is struggling to learn a topic in a one textbook, then the user may want to review a prerequisite topic that is taught in another textbook.

In some examples, aspects of the technology, including computerized implementations of methods according to the technology, can be implemented as a system, method, apparatus, or article of manufacture using standard programming or engineering techniques to produce software, firmware, hardware, or any combination thereof to control a processor device (e.g., a serial or parallel general purpose or specialized processor chip, a single- or multi-core chip, a microprocessor, a field programmable gate array, any variety of combinations of a control unit, arithmetic logic unit, and processor register, and so on), a computer (e.g., a processor device operatively coupled to a memory), or another electronically operated controller to implement aspects detailed herein. Accordingly, for example, examples of the technology can be implemented as a set of instructions, tangibly embodied on a non-transitory computer-readable media, such that a processor device can implement the instructions based upon reading the instructions from the computer-readable media. Some examples of the technology can include (or utilize) a control device such as an automation device, a special purpose or general-purpose computer including various computer hardware, software, firmware, and so on, consistent with the discussion below. As specific examples, a control device can include a processor, a microcontroller, a field-programmable gate array, a programmable logic controller, logic gates etc., and other typical components that are known in the art for implementation of appropriate functionality (e.g., memory, communication systems, power sources, user interfaces and other inputs, etc.).

Certain operations of methods according to the technology, or of systems executing those methods, can be represented schematically in the FIGS. or otherwise discussed herein. Unless otherwise specified or limited, representation in the FIGS. of particular operations in particular spatial order can not necessarily require those operations to be executed in a particular sequence corresponding to the particular spatial order. Correspondingly, certain operations represented in the FIGS., or otherwise disclosed herein, can be executed in different orders than are expressly illustrated or described, as appropriate for particular examples of the technology. Further, in some examples, certain operations can be executed in parallel, including by dedicated parallel processing devices, or separate computing devices configured to interoperate as part of a large system.

As used herein in the context of computer implementation, unless otherwise specified or limited, the terms “component,” “system,” “module,” “block,” and the like are intended to encompass part or all of computer-related systems that include hardware, software, a combination of hardware and software, or software in execution. For example, a component can be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) can reside within a process or thread of execution, can be localized on one computer, can be distributed between two or more computers or other processor devices, or can be included within another component (or system, module, and so on).

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of.” Further, a list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of each of A, B, and C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C. In general, the term “or” as used herein only indicates exclusive alternatives (e.g., “one or the other but not both”) when preceded by terms of exclusivity, such as “either,” “one of,” “only one of,” or “exactly one of.”

Although the present technology has been described by referring to preferred examples, those skilled in the art will recognize that changes can be made in form and detail without departing from the scope of the discussion.

What is claimed is:

1. A system, the system comprising:
a processing system including one or more electronic processors configured to:
receive electronic content that includes a plurality of content portions, wherein the plurality of content portions are arranged within the electronic content in a sequential order;
identify a plurality of nodes for the electronic content, wherein each of the plurality of nodes corresponds to one of the plurality of content portions;
determine, from the plurality of nodes, a plurality of node pairings based on the sequential order of the electronic content;
determine, using a large language model (LLM), a metric for each of the plurality of node pairings, wherein the metric indicates a respective degree of dependency associated with the corresponding node pairing; and
generate a graphical representation of the electronic content based on the metric for each of the plurality of node pairings, wherein the graphical representation indicates relationships between the plurality of content portions of the electronic content.

2. The system of claim 1, wherein the electronic content includes at least one of: an electronic textbook; an audio recording; a video recording; a slideshow; or a transcript.

3. The system of claim 1, wherein the processing system is configured to:
determine a granularity setting that establishes a degree of granularity at which nodes are to be identified for the electronic content,
wherein the processing system identifies the plurality of nodes in accordance with the granularity setting.

4. The system of claim 3, wherein the granularity setting includes at least one of:
a total number of nodes to be identified for the electronic content;
a range of nodes to be identified for the electronic content; or
a property of the electronic content that triggers nodes to be identified for the electronic content.

5. The system of claim 1, wherein the processing system is configured to:
determine a graph setting that establishes a characteristic of the graphical representation,
wherein the processing system generates the graphical representation in accordance with the graph setting.

6. The system of claim 5, wherein the characteristic includes at least one of: a graph type, a graph structure, or a maximum number of child nodes per parent node.

7. The system of claim 1, wherein each node pairing included in the plurality of node pairings includes: (i) a first respective node of the plurality of nodes that corresponds to a first respective content portion of the plurality of content portions; and (ii) a second respective node of the plurality of nodes that corresponds to a second respective content portion of the plurality of content portions, the first respective content portion preceding the second respective content portion in the sequential order of the electronic content.

8. The system of claim 1,
wherein the plurality of node pairings includes a first node pairing that includes: (i) a first node of the plurality of nodes corresponding to a first content portion pertaining to a first topic; and (ii) a second node of the plurality of nodes corresponding to a second content portion of the plurality of content portions pertaining to a second topic; and
wherein the processing system is configured to
determine a first metric for the first node pairing;
determine, based on the first metric, that the first topic is a prerequisite to the second topic; and
generate the graphical representation such that the graphical representation indicates that the first topic is a prerequisite to the second topic, wherein the graphical representation includes the first node as a predecessor to the second node.

9. The system of claim 1, wherein the graphical representation is an acyclic digraph or a directed acyclic digraph (DAG).

10. A method, the method comprising:
receiving, with a processing system including one or more electronic processors, a first electronic content including a plurality of content portions that are arranged within the first electronic content in a sequence;
generating, with the processing system, a plurality of nodes for the first electronic content, wherein each node of the plurality of nodes corresponds to one of the plurality of content portions of the first electronic content;
determining, with the processing system, a plurality of node pairings from the plurality of nodes;
executing, with the processing system, using a large language model (LLM), a first LLM query to determine a metric for each of the plurality of node pairings, wherein the metric indicates a degree of dependency for a respective node pairing of the plurality of node pairings;
receiving, with the processing system, a response to the first LLM query, wherein the response indicates the metric for each of the plurality of node pairings; and
generating, with the processing system, a graphical representation based on the metric for each of the plurality of node pairings, wherein the graphical representation indicates requisite relationships between the plurality of content portions of the first electronic content.

11. The method of claim 10, further comprising:
executing, with the processing system, using a second LLM, a second LLM query to determine a second metric for each of the plurality of node pairings, wherein the second metric indicates a second degree of dependency for the respective node pairing of the plurality of node pairings;
receiving, with the processing system, a second response to the second LLM query, wherein the second response indicates the second metric for each of the plurality of node pairings; and
determining, with the processing system, a difference between the metric and the second metric for each of the plurality of node pairings,
wherein generating, with the processing system, the graphical representation of the first electronic content includes generating the graphical representation based on the difference between the metric and the second metric for each of the plurality of node pairings.

12. The method of claim 10, wherein generating, with the processing system, the plurality of nodes for the first electronic content includes:
generating, with the processing system, using the LLM, an identifier for each of the plurality of nodes, wherein the identifier is based on a corresponding topic of a respective node of the plurality of nodes.

13. The method of claim 10, wherein generating, with the processing system, the plurality of nodes for the first electronic content includes:
extracting, with the processing system, an identifier for each of the plurality of nodes from the first electronic content, wherein the identifier for each of the plurality of nodes includes a preexisting identifier from the first electronic content.

14. The method of claim 10, further comprising:
receiving, with the processing system, a second electronic content including a second plurality of content portions;
generating, with the processing system, a second plurality of nodes for the second electronic content, wherein each node of the second plurality of nodes corresponds to one of the plurality of second content portions of the second electronic content; and
determining, with the processing system, a first node pairing of the plurality of node pairings, wherein the first node pairing includes:
(i) a first node from the plurality of nodes corresponding to a first content portion of the plurality of content portions that pertains to a first topic; and
(ii) a second node from the second plurality of nodes corresponding to a second content portion of the second plurality of content portions that pertains to a second topic,
wherein the first topic is a prerequisite to the second topic;
wherein generating, with the processing system, the graphical representation includes generating the graphical representation that indicates a requisite relationship between the first topic and the second topic by including an edge between the first node and the second node.

15. The method of claim 10, further comprising:
identifying, with the processing system, within the graphical representation, a set of redundant paths between a first node of the plurality of nodes and a second node of the plurality of nodes;
selecting, with the processing system, a first redundant path of the set of redundant paths to be removed based on a first quantity of edges included within the first redundant path in comparison to a second quantity of edges included within a second redundant path of the set of redundant paths; and
removing, with the processing system, the first redundant path.

16. The method of claim 15, wherein identifying, with the processing system, within the graphical representation, the set of redundant paths, includes:
identifying the first redundant path between the first node and the second node, wherein the first redundant path includes a first edge connecting the first node to the second node; and
identifying the second redundant path between the first node and the second node, wherein the second redundant path includes a second edge connecting the first node to a third node of the plurality of nodes and a third edge connecting the third node to the second node; and
wherein removing, with the processing system, the first redundant path includes removing the first edge from the graphical representation.

17. A non-transitory, computer-readable medium storing instructions that, when executed by an electronic processor, perform a set of functions, the set of functions comprising:
receiving electronic content that includes a plurality of content portions arranged within the electronic content in a sequential order, wherein the plurality of content portions includes a first content portion pertaining to a first topic and a second content portion pertaining to a second topic;
identifying a plurality of nodes for the electronic content, wherein the plurality of nodes includes a first node representing a first content portion of the plurality of content portions and a second node representing a second content portion of the plurality of content portions;
determining, from the plurality of nodes, a plurality of node pairings based on the sequential order of the electronic content, wherein the plurality of node pairings includes a first node pairing including the first node and the second node;
determining, using a large language model (LLM), a plurality of metrics based on the plurality of node pairings, wherein the plurality of metrics includes a first metric for the first node pairing, wherein the first metric indicates a requisite relationship between the first topic and the second topic; and
generating a graphical representation for the electronic content based on the plurality of metrics, wherein the graphical representation indicates the requisite relationship between the first topic and the second topic such that the graphical representation indicates that the first topic is a prerequisite to the second topic.

18. The computer-readable medium of claim 17, wherein generating the graphical representation for the electronic content includes generating a directed acyclic graph.

19. The computer-readable medium of claim 17, wherein the set of functions further comprises:
generating, for each of the plurality of nodes, an identifier that relates to a corresponding topic of a respective node of the plurality of nodes.

20. The computer-readable medium of claim 17, wherein the set of functions further comprises:
determining, based on user input, a granularity setting that establishes a degree of granularity at which nodes are to be identified for the electronic content, wherein the plurality of nodes are identified in accordance with the granularity setting; and
determining, based on user input, a graph setting that establishes a characteristic of the graphical representation, wherein the graphical representation is generated in accordance with the graph setting.
